(19) United States
(12) Patent Application Publication
(10) Pub. No.: US 2010/0272901 A1
(43) Pub. Date: Oct. 28, 2010

(54) THIN FILM FORMING APPARATUS AND THIN FILM FORMING METHOD

(76) Inventors: Yasuharu Shinokawa, Osaka (JP); Kazuyoshi Honda, Osaka (JP)

Correspondence Address: MCDERMOTT WILL & EMERY LLP, 600 13TH STREET, NW, WASHINGTON, DC, 20005-3096, US

(21) Appl. No.: 12/745,391

(22) PCT Filed: Nov. 19, 2008
(86) PCT No.: PCT/JP2008/003375

§ 371 Date: May 28, 2010

(30) Foreign Application Priority Data
Dec. 5, 2007 (JP) 2007-314300

(51) Int. Cl. B05D 3/04; B05C 11/00

(52) U.S. Cl. 427/294; 118/50

(57) ABSTRACT

In a film forming method using gas cooling, a decrease in a film formation rate and an excessive load on a vacuum pump due to the introduction of the gas are avoided while achieving an adequate cooling effect. A thin film forming apparatus of the present invention includes: a cooling body 10 provided close to a rear surface of a substrate 7 in a thin film forming region 14; a gas introducing unit configured to for introduce a gas to between the cooling body 10 and the rear surface of the substrate 7; and a gap maintaining unit 11 contacting the rear surface of the substrate 7 for dividing the thin film forming region 14 into a first thin film forming region 14a and a second thin film forming region 14b where a film forming speed is lower than that in the first thin film forming region 14a, and maintaining a gap between the cooling body 10 and the substrate 7. In addition, a condition for the cooling is set such that an amount of cooling in the first thin film forming region 14a is larger than an amount of cooling in the second thin film forming region 14b.

### TECHNICAL FIELD

The present invention relates to a thin film forming apparatus and a thin film forming method.

### BACKGROUND ART

A thin film technology is widely used to enhance device performances and reduce device sizes. Realizing thin-film devices brings direct merits to users, and in addition, plays an important role from an environmental point of view, such as protection of earth resources and a reduction in power consumption.

For the development of the thin film technology, it is essential to respond to demands from industrial use, such as increases in efficiency, stability, and productivity of the thin film manufacturing method and a reduction in cost of the thin film manufacturing method. Therefore, efforts to respond to those demands are being continued.

In order to realize the increase in productivity of the thin film, a high-deposition-rate film forming technology is essential. In the thin film manufacture, such as vacuum deposition, sputtering, ion plating, and CVD, an increase in deposition rate is being promoted. Used as a method for continuously mass-producing the thin film is a take-up type thin film manufacturing method. The take-up type thin film manufacturing method is a method for pulling out an elongated substrate, rolled in a roll shape, from a pull-out roll, forming the thin film on the substrate while the substrate is transferred along a transfer system, and taking up the substrate by a take-up roll. By combining this manufacturing method with a high-deposition-rate film forming source, such as a vacuum deposition source using an electron beam, the thin film can be formed with high productivity.

One factor determining success and failure of such continuous take-up type thin film manufacturing is a problem of a heat load during film formation. For example, in the case of the vacuum deposition, radiation heat from the evaporation source and heat energy to which motion energy of evaporated atoms is changed are applied to the substrate to increase the temperature of the substrate. Especially in a case where the temperature of the evaporation source is increased or the evaporation source and the substrate are provided close to each other to increase the deposition rate, the temperature of the substrate increases excessively. If the temperature of the substrate becomes too high, the mechanical characteristic of the substrate significantly deteriorates. This may cause problems, such as a large deformation of the substrate by heat expansion of the deposited thin film and meltdown of the substrate. In the other film forming methods, although the heat source is different, the heat load is applied to the substrate during the film formation, and this causes the same problems.

In order to prevent the substrate from deforming, melting down, or the like, the substrate is cooled down during the film formation. An operation of forming the film with the substrate provided along a cylindrical can disposed on a passage of the transfer system is widely carried out to cool down the substrate. By securing thermal contact between the substrate and the cylindrical can by this method, the heat can be transferred to the cooling can having a high heat capacity. Therefore, the temperature of the substrate can be prevented from increasing, and the temperature of the substrate can be kept at a specific temperature.

One of methods for securing the thermal contact between the substrate and the cylindrical can in a vacuum atmosphere is a gas cooling method. The gas cooling method is a method for cooling down the substrate such that: a small gap of several millimeters or less is kept between the substrate and the cylindrical can that is a cooling body; a minute amount of gas is supplied to the gap; and the thermal contact between the substrate and the cylindrical can is secured by utilizing gas heat conduction. Document 1 describes that in an apparatus configured to form the thin film on a web that is the substrate, the gas is supplied to a region between the web and the cylindrical can that is a supporting unit. In accordance with this, since the thermal conduction between the web and the supporting unit can be secured, the increase in temperature of the substrate can be suppressed.

As a means for cooling the substrate, a cooling belt can also be used instead of the cylindrical can. In the case of forming the film by oblique incidence, forming the film with the substrate moving linearly is advantageous from a viewpoint of the use efficiency of a material. In this case, it is effective to use the cooling belt as the substrate cooling unit. Document 2 discloses a method for cooling down a belt in a case where the belt is used to transfer and cool down the material of the substrate. In accordance with Document 2, in order to cool down a cooling band in the thin film forming apparatus which applies a heat load, a cooling mechanism using a double or more cooling band or a liquid medium is provided inside the cooling body. With this, the cooling efficiency can be increased. Therefore, an electromagnetic tape characteristic, such as an electromagnetic conversion characteristic, can be improved, and the productivity can also be improved significantly.

Document 1: Japanese Laid-Open Patent Application Publication No. 1-152262

Document 2: Japanese Laid-Open Patent Application Publication No. 6-145982

### DISCLOSURE OF THE INVENTION

### Problems to be Solved by the Invention

In the case of forming the film by the oblique incidence, forming the film using the cooling belt described in Document 2 with the substrate moving linearly is advantageous from a viewpoint of the use efficiency of the material. However, in a case where the heat load on the substrate is high due to, for example, especially a high film formation rate, it is difficult to adequately cool down the substrate. This is because in a case where the substrate moves linearly, a vertical-direction power of the substrate cannot be obtained, and a power toward the cooling body cannot be secured. In a case where the power toward the cooling body is not secured, the thermal contact between the substrate and the cooling body cannot be secured adequately.

In the case of carrying out gas cooling described in Document 1 in order to adequately secure the thermal contact between the substrate and the cooling body, increasing the pressure of the cooling gas between the substrate and the cooling body is effective to improve a cooling performance. Therefore, it is desirable to increase the gas pressure between the substrate and the cooling body by setting the interval between the substrate and the cooling body as small as possible and adjusting the flow rate of the introduced cooling gas to be high. However, in a case where an introduction amount of cooling gas increases, the cooling gas easily leaks from the gap between the cooling body and the substrate, and this increases the pressure in a film forming chamber. As a result, a film formation rate decreases, and in addition, an excessive load is applied to a vacuum pump configured to depressurize the inside of the film forming chamber.

Moreover, when consecutively forming the thin film on the traveling substrate while carrying out the gas cooling, a high tension is applied to the substrate in a substrate traveling direction in order that the gap between the cooling body and the substrate is maintained uniform and highly accurate. Therefore, partial distortion of the substrate may cause traveling instability and deflection. Especially in a case where the substrate is, for example, a metal foil having high stiffness, the partial distortion of the substrate cannot be prevented since the metal foil is substantially inextensible. As a result, the gap between the cooling body and the substrate tends to become large beyond necessity, and there is a high possibility that the cooling gas leaks from the gap and this increases the pressure in the film forming chamber.

Further, in a case where a substrate 7 transferred linearly is cooled down by a cooling body 10 as shown in FIG. 5, a power acting in a direction in which the substrate is pressed toward the cooling body cannot be obtained. Therefore, the gap between the substrate and the cooling body tends to become large by the introduction of the gas. On this account, the cooling gas leaks significantly.

As above, in the gas cooling method which aims to secure the thermal contact between the traveling substrate and the cooling body under vacuum atmosphere, in a case where the introduction amount of gas is increased to achieve an adequate cooling effect, the pressure in the film forming chamber increases by the leakage of the cooling gas. Therefore, the film formation rate decreases, and the excessive load is applied to the vacuum pump. Especially in a case where the substrate travels linearly, the gas leakage tends to increase, so that this problem becomes significant. In contrast, in a case where the introduction amount of gas is decreased, the adequate cooling effect cannot be obtained, so that deformation and meltdown of the substrate by the heat load tend to occur.

The present invention was made in light of the above problems, and an object of the present invention is to provide a thin film forming apparatus and a thin film forming method, each of which, when consecutively forming the thin film on a front surface of the substrate being transferred linearly, can adequately achieve the cooling effect in the gas cooling which aims to prevent the deformation and meltdown of the substrate due to the heat load at the time of film formation and can avoid the decrease in the film formation rate and the excessive load on the vacuum pump due to the introduction of the gas.

### Means for Solving the Problems

In order to solve the above problems, a thin film forming apparatus of the present invention is a thin film forming apparatus configured to form a thin film in vacuum on a front surface of a band-shaped substrate having the front surface and a rear surface, the thin film forming apparatus including: a transfer mechanism configured to transfer the substrate; a thin film forming unit configured to form the thin film on the front surface of the substrate in a thin film forming region, the substrate being transferred linearly; a cooling body provided close to the rear surface of the substrate in the thin film forming region and cooled down by a cooling medium; a gas introducing unit configured to introduce a gas to between the cooling body and the rear surface of the substrate to cool down the substrate; a gap maintaining unit contacting the rear surface of the substrate for dividing the thin film forming region into a first thin film forming region and a second thin film forming region where a film forming speed is lower than that in the first thin film forming region, and maintaining a gap between the cooling body and the substrate; and a vacuum container configured to store the transfer mechanism, the thin film forming unit, the cooling body, the gas introducing unit, and the gap maintaining unit, wherein in cooling of the substrate by the gas introducing unit, a condition for the cooling is set such that an amount of cooling of the substrate in the first thin film forming region is larger than an amount of cooling of the substrate in the second thin film forming region.

Here, the expression “substrate being transferred linearly” intends to exclude a case where the substrate is transferred while being bent along a cylindrical can. Specifically, as shown in FIG. 1, the expression “substrate being transferred linearly” denotes that the substrate is transferred while tension is applied to the substrate in the traveling direction by a plurality of feed rollers. However, the expression includes, in a cross-sectional view, not only a case where the substrate is transferred completely linearly as shown in FIG. 5 but also a case where the substrate is transferred while slightly curving as shown in FIGS. 2 and 4.

Moreover, a thin film forming method of the present invention is a thin film forming method for forming a thin film in vacuum using the thin film forming apparatus on a front surface of a band-shaped substrate having the front surface and a rear surface, and the method includes the step of: forming the thin film on the front surface of the substrate under a condition in which in cooling of the substrate by the gas introducing unit, an amount of cooling of the substrate in the first thin film forming region is larger than an amount of cooling of the substrate in the second thin film forming region.

### EFFECTS OF THE INVENTION

In accordance with the present invention, in gas cooling which aims to prevent the substrate from deforming or melting down due to a heat load during film formation, a condition for the cooling can be individually adjusted for each of a plurality of thin film forming regions where a film forming speed is different, and therefore, a heat load is also different. On this account, the amount of cooling can be optimized in accordance with the heat load on each of the thin film forming regions. With this, by efficiently cooling down the thin film forming region where the heat load is high, the amount of gas leaking from the gap between the cooling body and the substrate can be reduced while achieving the adequate cooling effect in the entire thin film forming region. Therefore, the decrease in the film formation rate due to the increase in the pressure of the film forming chamber can be avoided, and the unnecessary load on the vacuum pump can be reduced.

### BRIEF DESCRIPTION OF DRAWINGS

FIG. 1 is a schematic diagram showing one example of the configuration of an entire film forming apparatus of the present invention.

FIG. 2 are schematic structural diagrams each showing one example of a substrate cooling mechanism that is a part of Embodiment 1 of the present invention. FIG. 2(a) is a cross-sectional view taken along line A-A′ of FIG. 2(b). FIG. 2(b) is a front view when viewed from a rear surface side of a substrate 7.

FIG. 3 are schematic structural diagrams each showing another example of the substrate cooling mechanism that is a part of Embodiment 1 of the present invention. FIG. 3(a) is a cross-sectional view taken along line B-B′ of FIG. 3(b). FIG. 3(b) is a front view when viewed from a rear surface side of the substrate 7. FIG. 3(c) is a partially enlarged view of a gas nozzle 19.

FIG. 4 is a schematic structural diagram showing one example of the substrate cooling mechanism that is a part of Embodiment 2 of the present invention.

FIG. 5 is a schematic structural diagram showing one example of the substrate cooling mechanism of Comparative Example.

### EXPLANATION OF REFERENCE NUMBERS

1 vacuum container
2 pull-out roller
3 feed roller
4 take-up roller
5 film forming source
6 shielding plate
7 substrate
8 exhaust unit
10 cooling body
11 gap maintaining unit
12 gas flow controller
13 pipe
14 thin film forming region
14a first thin film forming region
14b second thin film forming region
15 cooling gas supplying unit
16 manifold
17 fine hole
18a, 18b cooling medium pipe
19 gas nozzle

### BEST MODE FOR CARRYING OUT THE INVENTION

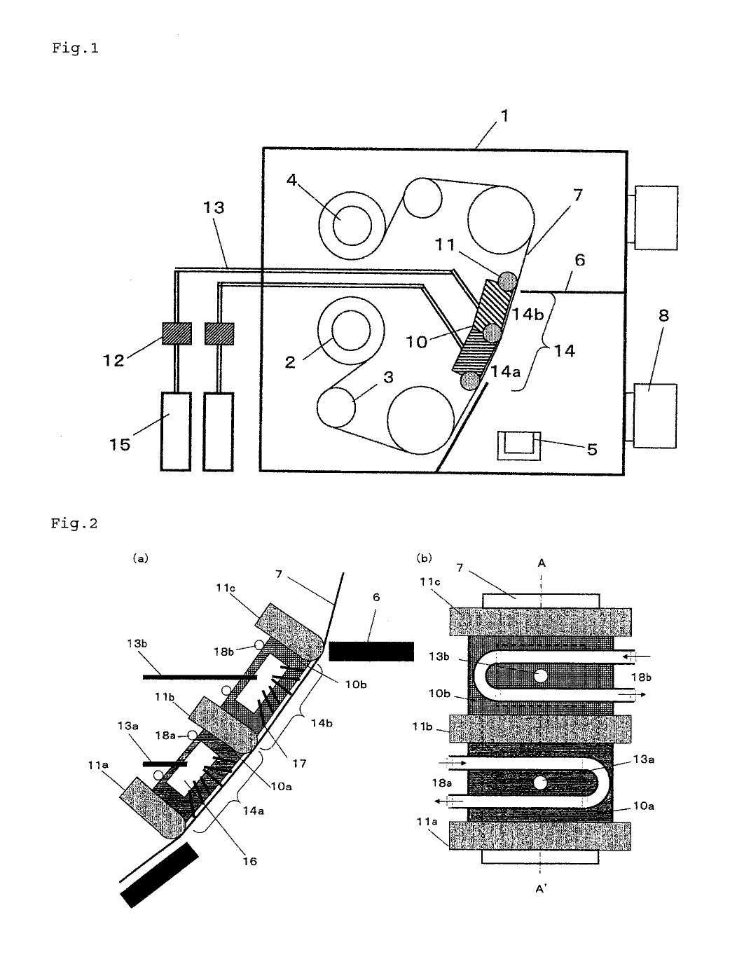

One example of the configuration of an entire film forming apparatus is schematically shown in FIG. 1. A vacuum container 1 is a pressure-resistant container-like member having an internal space. A pull-out roller 2, a plurality of feed rollers 3, a thin film forming region 14, a take-up roller 4, a film forming source 5, and a shielding plate 6 are stored in the internal space. The pull-out roller 2 is a roller-like member provided to be rotatable around a center axis thereof. A band-shaped elongated substrate 7 winds around a surface of the pull-out roller 2. The pull-out roller 2 supplies the substrate 7 to the closest feed roller 3.

Various polymer films, various metal foils, a complex of the polymer film and the metal foil, and elongated substrates of the other materials can be used as the substrate 7. Examples of the polymer film are polyethylene terephthalate, polyethylene naphthalate, polyamide, and polyimide. Examples of the metal foil are aluminum foils, copper foils, nickel foils, titanium foils, and stainless steel foils. The substrate has a width of, for example, 50 to 1,000 mm and desirably has a thickness of, for example, 3 to 150 μm. In a case where the substrate has a width of less than 50 mm, a large amount of gas leaks during the gas cooling. However, the present invention is not inapplicable to this case. In a case where the substrate has a thickness of less than 3 μm, the heat capacity of the substrate is extremely small, so that the heat deformation easily occurs. In a case where the substrate has a thickness of more than 150 μm, the metal foil is substantially inextensible even by the tension applied by the pull-out roller 2 or the take-up roller 4. Therefore, the partial distortion of the substrate cannot be prevented, and the gap between the cooling body and the substrate is easily formed. Thus, a large amount of gas leaks during the gas cooling. However, the present invention is not inapplicable to these cases. A transfer speed of the substrate differs depending on the type of the thin film to be formed and conditions for the film formation, but is, for example, 0.1 to 500 m/min. A tension applied in the traveling direction of the substrate being transferred is suitably selected depending on the material and thickness of the substrate and process conditions, such as the film formation rate.

Each of the feed rollers 3 is a roller-like member provided to be rotatable around a center axis thereof. The feed rollers 3 guide the substrate 7, supplied from the pull-out roller 2, to the thin film forming region 14 and finally guide the substrate 7 to the take-up roller 4. When the substrate 7 travels the thin film forming region 14, material particles flying from the film forming source reacts with a material gas introduced from the material gas introduction tube (not shown) according to need to be deposited on the substrate 7. Thus, a thin film is formed on a front surface of the substrate 7. The take-up roller 4 is a roller-like member provided to be rotatable by a driving unit, not shown. The take-up roller 4 takes up and stores the substrate 7 on which the thin film is formed.

Various film forming sources can be used as the film forming source 5. Examples are evaporation sources using resistance heating, induction heating, and electron beam heating, ion plating sources, sputtering sources, and CVD sources. In addition, as the film forming source, a combination of an ion source and a plasma source can be used. For example, the film forming source includes a container-like member and a film forming material. The container-like member is provided under a lowermost portion of the thin film forming region 14 in a vertical direction, and a vertically upper portion thereof is open. The film forming material is mounted inside the container-like member. A heating unit, such as an electron gun (not shown) or an induction coil, is provided in the vicinity of the film forming source. The material in the container-like member is heated and evaporates by the heating unit. The vapor of the material moves upward in the vertical direction to adhere to the front surface of the substrate 7 in the thin film forming region. Thus, the thin film is formed. The film forming source 5 applies a heat load to the substrate.

The shielding plate 6 limits a region where the material particles flying from the film forming source 5 contact the substrate 7 to only the thin film forming region 14.

An exhaust unit 8 is provided outside the vacuum container 1 and adjusts the inside of the vacuum container 1 to a pressure reduced state suitable for the formation of the thin film. For example, the exhaust unit 8 is constituted by various vacuum exhaust systems including as a main pump an oil diffusion pump, a cryopump, a turbo-molecular pump or the like.

On a rear surface side of the substrate located in the thin film forming region 14, a cooling body 10 is provided close to the substrate. A distance between the cooling body and the substrate is maintained by a plurality of gap maintaining unit 11 with high accuracy to prevent the substrate and the cooling body from contacting each other. Further, a gas, the introduction amount of which is controlled by a gas flow controller 12, is supplied through a pipe 13 to the gap between the cooling body 10 and the substrate 7. Here, the thin film forming region 14 is divided into a first thin film forming region 14a and a second thin film forming region 14b by one of the plurality of gap maintaining unit 11. By optimizing the introduction amount of cooling gas introduced to each region, the type of the cooling gas, and the like, the amount of gas leaking from the gap between the cooling body and the substrate can be reduced, and an adverse affect on the film formation rate and a load on a vacuum pump 8 can be reduced while maintaining an adequate cooling effect. Moreover, examples of a cooling gas supplying unit 15 are a gas bomb and a gas generator.

A material of the cooling body 10 is not especially limited. Examples are metals, such as copper, aluminum, and stainless steel, which can secure a worked shape, carbons, various ceramics, and engineering plastics. Especially, it is more preferable to use the metal, such as copper or aluminum, having high heat conductivity, since such metal is unlikely to generate dust and excels in the heat resistance, and the temperature of such metal is easily uniformized.

As above, in accordance with the thin film forming apparatus of the present invention, the substrate 7 supplied from the pull-out roller 2 travels through the feed roller 3 and is supplied with the vapor flying from the evaporation source 5 in the thin film forming region 14, and thus, the thin film is formed on the substrate. The substrate 7 travels through the other feed roller 3 to be taken up by the take-up roller 4. Thus, the substrate 7 having the front surface on which the thin film is formed is obtained.

Substrate cooling conditions adjusted in the present invention may include various conditions. Examples of the conditions are the type, flow rate, and temperature of the cooling medium for cooling down the cooling body, the flow rate, type, and temperature (gas introduction conditions) of the gas introduced to the gap between the cooling body and the rear surface of the substrate, and the distance of the gap maintained by the gap maintaining unit. One of the conditions may be adjusted, or a combination of two or more of the conditions may be adjusted.

### Embodiment 1

FIG. 2 are diagrams each schematically showing the configuration of one example of a substrate cooling mechanism that is a part of Embodiment 1 of the present invention. FIG. 2(a) is a cross-sectional view taken along line A-A′ of FIG. 2(b). FIG. 2(b) is a front view when viewed from the rear surface side of the substrate 7.

The gap between the cooling body and the rear surface of the substrate is maintained by three gap maintaining unit 11a, 11b, and 11c. These three gap maintaining unit 11a, 11b, and 11c are arranged in this order from an upstream side in the substrate traveling direction. The gap maintaining unit 11a and 11c located on both sides are arranged near both ends of the thin film forming region 14 in the substrate traveling direction. The gap maintaining unit 11b located at a center is arranged substantially at a center of the thin film forming region 14. The gap maintaining unit 11b divides the thin film forming region 14 into the first thin film forming region 14a located on an upstream side in the substrate traveling direction and the second thin film forming region 14b located on a downstream side in the substrate traveling direction. To be specific, the first thin film forming region 14a is located upstream of a contact position where the gap maintaining unit 11b located at the center and the rear surface of the substrate contact each other. The second thin film forming region 14b is located downstream of the contact position. A cooling body 10a is provided on the rear surface side of the substrate in the first thin film forming region 14a, and a cooling body 10b is provided on the rear surface side of the substrate in the second thin film forming region 14b. The cooling conditions for respective thin film forming regions are adjusted such that the amount of cooling by the cooling body 10a is larger than the amount of cooling by the cooling body 10b.

The thin film forming region 14 inclines with respect to the vertical direction. A distance between the film forming source 5 and the first thin film forming region 14a is different from a distance between the film forming source 5 and the second thin film forming region 14b. Since the first thin film forming region 14a is closer to the film forming source 5, a film forming speed is higher in the first thin film forming region 14a than in the second thin film forming region 14b, but a heat load is also higher in the first thin film forming region 14a than in the second thin film forming region 14b. Therefore, the cooling conditions are adjusted such that the amount of cooling in the first thin film forming region becomes larger than the amount of cooling in the second thin film forming region.

The cooling bodies 10a and 10b are respectively provided with cooling medium pipes 18a and 18b and are cooled down by the cooling medium, such as cooling water or an antifreezing fluid, flowing through the cooling medium pipes. A material of the cooling medium pipe is not especially limited, and a pipe made of copper, stainless steel, or the like may be used. The cooling medium pipe may be welded to the cooling body 10. By setting the type, temperature, and flow rate of the cooling medium flowing through the cooling medium pipe 18a and the type, temperature, and flow rate of the cooling medium flowing through the cooling medium pipe 18b to be different from each other, the amount of cooling by the cooling body 10a can be set to be different from the amount of cooling by the cooling body 10b. For example, the cooling body 10a can be cooled down to be lower in temperature than the cooling body 10b.

As a method for introducing the gases in accordance with different gas introduction conditions, for example, there is a method for adjusting respective gas flow rates by the gas flow controllers 12 (shown in FIG. 1) and supplying the gases from cooling gas pipes 13a and 13b, provided for the respective cooling bodies, through manifolds 16 and fine holes 17 extending toward the surface of the cooling bodies. Moreover, as a method for introducing the cooling gas from the cooling bodies 10a and 10b, various methods can be used, such as a method for embedding a gas nozzle having a flute-like outlet shape in the cooling body and introducing the gas from the nozzle and a method for using a porous sintered metal, porous ceramic, or the like as the cooling body and introducing the gas using the fine holes.

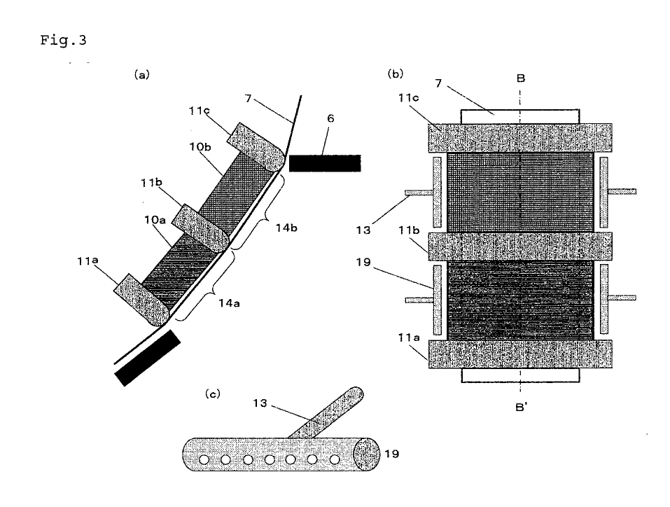

Moreover, as shown in FIG. 3 (the cooling medium pipe is not shown), the introduction of the gas can be carried out from a gas nozzle 19 provided outside the cooling body without causing the gas to flow through the cooling body. In the case of introducing the gas to the gap between the cooling body and substrate without causing the gas to flow through the cooling body, the amount of gas leakage may become large. Therefore, for example, it is preferable that a nozzle hole diameter of the gas nozzle 19 be reduced to about 0.1 to 0.2 mm such that the gas nozzle 19 has directivity. FIG. 3(c) shows an enlarged view of the gas nozzle 19. FIG. 3 show a method for introducing the gas from a width-direction end surface of the substrate. However, the gas may be introduced from a substrate longitudinal direction (vertical direction in FIG. 3(b)). The method for introducing the gas is not limited to these, and the other method can be used as long as the gases as heat transfer mediums can be respectively introduced to the gaps between each cooling body and the substrate while controlling the gases individually.

The gap maintaining unit 11 shown in FIGS. 2 and 3 is a member which supports the substrate to prevent the cooling body 10 and the substrate 7 from contacting each other. The gap maintaining unit 11 in a fixed state contacts the rear surface of the traveling substrate 7. Therefore, the surface nature and shape of the gap maintaining unit 11 need to be selected to prevent the gap maintaining unit 11 from damaging the rear surface of the substrate. Moreover, it is preferable that a positional relation between the cooling body and the gap maintaining unit be set such that the interval of the gap (space) between the cooling body and the substrate which is maintained by the gap maintaining unit is 0.1 to 2 mm in a state where the gas is introduced to the gap. It is more preferable that the interval be 0.3 to 1 mm. In a case where the interval is less than 0.1 mm, there is a high possibility that the cooling body and the substrate partially contact each other, and the substrate is easily damaged. In a case where the interval exceeds 2 mm, the gap between the cooling body and the substrate is too large, so that the cooling gas easily leaks, and the cooling performance significantly deteriorates.

It is desirable that the gas introduction conditions be adjusted such that the amount of gas introduced to the first thin film forming region 14a becomes larger than the amount of gas introduced to the second thin film forming region 14b. This is because since the first thin film forming region 14a is closer to the film forming source 5 than the second thin film forming region 14b, the film forming speed is higher, and the heat load during the film formation is higher.

As above, in the thin film forming region where the heat load is higher, a larger amount of gas is introduced to maintain the gas pressure and to improve the cooling performance. In contrast, in the thin film forming region where the heat load is lower, the introduction amount of gas is suppressed. To be specific, by adjusting the introduction amount of cooling gas in accordance with the distance from the film forming source, the total introduction amount of gas can be suppressed while maintaining the appropriate cooling effect.

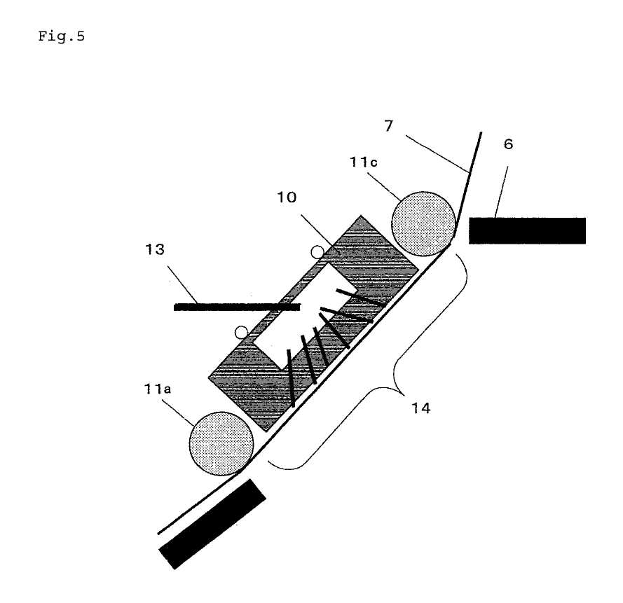

FIG. 5 shows the gas introducing method of Comparative Example in which the cooling gas is uniformly introduced to the entire thin film forming region without dividing the thin film forming region. In accordance with this method, since high cooling performance is required in a part (lower part in FIG. 5) of the thin film forming region which part is close to the film forming source and in which part the heat load is high, the gas flow rate (gas pressure) needs to be increased based on this high cooling performance. Therefore, the amount of gas leaking from the gap between the cooling body and the substrate also increases. To be specific, in Comparative Example, although the amount of cooling required in a part (upper part in FIG. 5) of the thin film forming region which part is far from the film forming source and in which part the heat load is low is comparatively small, a large amount of gas is introduced beyond necessity. Therefore, the leakage of a wasteful gas causes the decrease in the film formation rate and the unnecessary load on the vacuum pump.

Therefore, as in the present invention, by selecting the appropriate introduction amount of gas for each of a plurality of thin film forming regions which are different in the heat load from each other, the total introduction amount of gas can be reduced without deteriorating the appropriate cooling effect. In addition, the amount of gas leaking from the gap between the cooling body and the substrate can be reduced, and the adverse affect on the film formation and the load on the vacuum pump can be reduced.

FIG. 1 shows an example regarding the thin film forming region on one inclined surface. However, the thin film forming apparatus of the present invention may include two or more inclined surfaces. For example, the thin film forming apparatus of the present invention may include a film formation traveling system of a mountain type, a V type, a W type, or an M type. Further, the film formation may be carried out with respect to not only one surface of the substrate but also both surfaces of the substrate. Further, the thin film forming region may be arranged horizontally.

Moreover, in FIG. 1, by arranging three gap maintaining unit 11, the thin film forming region is divided into two regions that are the first thin film forming region 14a and the second thin film forming region 14b. However, the present invention is not limited to this. The thin film forming region may be divided into three or more thin film forming regions by arranging four or more gap maintaining unit 11. For example, by arranging three to six gap maintaining unit, the thin film forming region can be divided into two to five regions. The introduction amount of gas can be optimized more properly if the number of thin film forming regions is larger. However, it is not preferable that the number of gap maintaining unit be five or more. This is because the region where the cooling body and the substrate are located close to each other decreases, and this deteriorates the cooling performance.

### Embodiment 2

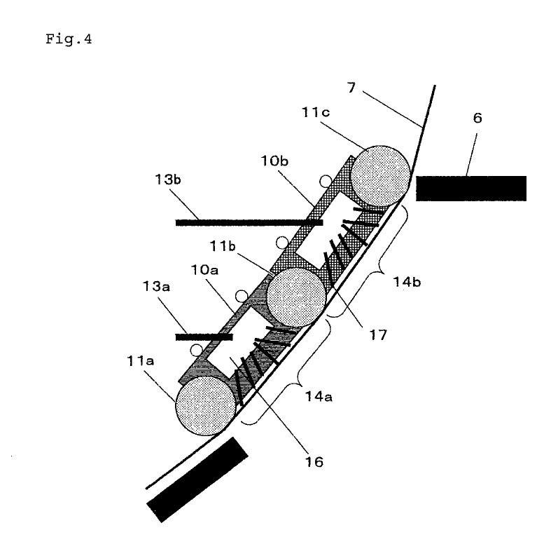

FIG. 4 is a diagram schematically showing the configuration of one example of the substrate cooling mechanism that is a part of Embodiment 2 of the present invention. The present embodiment is similar to Embodiment 1 except for the vicinity of the thin film forming region, so that the same explanations are omitted.

Each of the gap maintaining unit 11 configured to maintain the gap between the cooling body 10a and the substrate 7 in the first thin film forming region 14a and the gap between the cooling body 10b and the substrate 7 in the second thin film forming region 14b is constituted by a roller. In this case, since the gap maintaining unit rotates, the substrate is unlikely to be damaged by the contact between the gap maintaining unit and the substrate, which is preferable. Rubber or plastic can be used as a material of a surface of the roller which surface contacts the substrate. However, it is preferable to use a metal in order to avoid a risk of an organic substance transcription to the substrate due to the heat load on the substrate.

It is preferable that the roller have a diameter of 5 to 100 mm. It is not preferable that the diameter of the roller be less than 5 mm. This is because in a case where high tension is applied to the substrate to suppress the deformation of the substrate caused by the distortion of the substrate, the strength of the roller is low, so that the roller itself may deform. It is not preferable that the diameter of the roller exceed 100 mm. This is because since the roller diameter is large, the region where the substrate is cooled down by the cooling body is limited.

It is desirable that the gas introduction conditions be adjusted such that a molecular weight of each of molecules forming the gas introduced to the first thin film forming region 14a is lower than a molecular weight of each of molecules forming the gas introduced to the second thin film forming region 14b. This is because since the first thin film forming region 14a is closer to the film forming source 5 than the second thin film forming region 14b, the heat load during the film formation is higher.

By adjusting the type of the cooling gas in accordance with the distance from the film forming source, the adverse affect on the film forming step and the load on the vacuum pump can be reduced.

As the gas molecule which is low in the molecular weight, for example, hydrogen, helium, methane, ammonia, hydrogen fluoride, or neon can be used. However, in light of safety (handleability) and cost, helium is preferably used. The gas molecule, such as helium, which is low in the molecular weight is preferable in that the cooling performance is excellent because of high heat conductivity, and the influence of collision with the flying material molecules during the film formation is small. In contrast, the gas molecule, such as helium, is not preferable in that since the gas easily leaks from the gap between the cooling body and the substrate, it is difficult to maintain the gas pressure, and it is also difficult to discharge the leaked gas by the vacuum pump (especially a cryopump system).

As the gas molecule which is high in the molecular weight, for example, xenon, krypton, carbon dioxide, argon, or oxygen can be used. However, in light of cost and the like, oxygen or argon is preferably used. Moreover, in the case of carrying out reactive film formation in which the flying material molecule and the oxygen react with each other during the film formation or in the case of preventing a cooled surface (rear surface) of the substrate from oxidizing, it is preferable to use the inactive gas, such as argon. The gas molecule, such as argon, which is high in the molecular weight, is preferable in that the gas leakage from the gap between the cooling body and the substrate is unlikely to occur, and the gas pressure is easily maintained. However, the gas molecule, such as argon, is not preferable in that since the heat conductivity is low, the cooling performance is low, and problems, such as the decrease in the film formation rate due to the collision with the flying material molecule during the film formation, occur.

To be specific, it is desirable to introduce the gas, such as helium, to the first thin film forming region 14a which requires adequate cooling because of high heat load, and it is desirable to introduce the gas, such as argon, to the second thin film forming region 14b which requires a comparatively small amount of cooling because of low heat load.

In the gas introducing method of Comparative Example shown in FIG. 5, in the case of using the gas, such as helium, of molecules, each of which is low in the molecular weight, the gas leaks beyond necessity from the upper part where the heat load is low, and the load on the vacuum pump becomes high, which is not preferable. In contrast, in the case of using the gas, such as argon, of molecules, each of which is high in the molecular weight, the cooling performance is inadequate in the lower part where the heat load is high. Therefore, it is necessary to increase the gas pressure by increasing the gas flow rate, and the film formation rate decreases by the gas having leaked to the vicinity of the film forming source, which is not preferable.

As above, Embodiment 2 has explained a case where the amount of cooling is adjusted using a plurality of gases which are different in the molecular weight from each other. Embodiment 1 has explained that the amount of cooling is adjusted by the gas flow rate. As the method for adjusting the amount of cooling, the above-described various methods can be used. In any embodiment, one of these methods can be suitably selected, or these methods can be combined.

FIGS. 2 to 4 show that the interval of the gap between the cooling body 10a and the substrate 7 in the first thin film forming region 14a is substantially the same as the interval of the gap between the cooling body 10b and the substrate 7 in the second thin film forming region 14b. However, these intervals of the gaps may be different from each other. Especially, it is preferable that the interval of the gap between the cooling body 10a and the substrate 7 in the first thin film forming region 14a be narrower than the interval of the gap between the cooling body 10b of the substrate 7 in the second thin film forming region 14b. With this, the amount of cooling of the substrate in the first thin film forming region 14a can be set to be larger than the amount of cooling of the substrate in the second thin film forming region 14b. For this purpose, it is preferable that the positional relation between the cooling body and the gap maintaining unit be set such that the interval of the gap between the cooling body and the substrate in the first thin film forming region 14a is not less than 0.1 mm and less than 0.5 mm, and the interval of the gap between the cooling body and the substrate in the second thin film forming region 14b is not less than 0.5 mm and not more than 2 mm. These numerical values are numerical values in a state where the gas has been introduced to the gap.

Moreover, each of FIGS. 2 to 4 shows an example in which the lengths of the first thin film forming regions 14a and 14b are substantially the same as each other. However, the lengths of the regions 14a and 14b do not have to be the same as each other. For example, only a portion where the heat load is extremely high may be regarded as 14a (for example, half the length in FIG. 4), and the other portion may be regarded as 14b (for example, 1.5 times the length in FIG. 4). Moreover, as described above, the thin film forming region may be divided into three or more regions. With this, a combination of the gas flow rate and the gas type (molecular weight and the like) can be optimized in accordance with the magnitude of the heat load and the distribution of the heat load.

The foregoing has explained examples of the substrate cooling mechanism that is a part of each of the embodiments of the present invention. However, the present invention is not limited to these embodiments. It is possible to use the other method capable of individually adjusting the cooling conditions of a plurality of thin film forming regions divided by the gap maintaining unit.

Moreover, an inclination angle of the thin film forming region can be optimized if necessary. Since the oblique incidence film formation can form the thin film having microspaces by a self-shadowing effect, it is effective for the formation of a high C/N electromagnetic tape, the formation of a battery negative terminal having an excellent cycle characteristic, and the like.

For example, by using a copper foil as the substrate, evaporating silicon from the evaporation source, and introducing an oxygen gas according to need, an elongated battery polar plate can be obtained.

Moreover, by using polyethylene terephthalate as the substrate, evaporating cobalt from an evaporation crucible, and introducing the oxygen gas, an elongated electromagnetic tape can be obtained.

The embodiments for carrying out the present invention has been specifically described. However, the present invention is not limited to these.

Moreover, the battery polar plate using silicon, the electromagnetic tape, and the like have been explained as specific examples of the application of the present invention. However, the present invention is not limited to these. Needless to say, the present invention is applicable to various devices, such as condensers, various sensors, solar batteries, various optical films, moisture-proof films, and electrically-conductive films, which require stable film formation.

### INDUSTRIAL APPLICABILITY

In accordance with the thin film forming apparatus and the thin film forming method of the present invention, the adequate cooling effect can be achieved in the entire thin film forming region while avoiding disadvantages caused by the gas introduction of the gas cooling method. Therefore, the present invention can carry out the thin film formation realizing both high material use efficiency and high film formation rate while preventing the substrate from deforming, melting down, or the like.

1. A thin film forming apparatus configured to form a thin film in vacuum on a front surface of a band-shaped substrate having the front surface and a rear surface,
the thin film forming apparatus comprising:
a transfer mechanism configured to transfer the substrate;
a thin film forming unit configured to form the thin film on the front surface of the substrate in a thin film forming region, the substrate being transferred linearly;
a cooling body provided close to the rear surface of the substrate in the thin film forming region and cooled down by a cooling medium;
a gas introducing unit configured to introduce a gas to between the cooling body and the rear surface of the substrate to cool down the substrate;
a gap maintaining unit contacting the rear surface of the substrate for dividing the thin film forming region into a first thin film forming region and a second thin film forming region where a film forming speed is lower than that in the first thin film forming region, and maintaining a gap between the cooling body and the substrate; and
a vacuum container configured to store the transfer mechanism, the thin film forming unit, the cooling body, the gas introducing unit, and the gap maintaining unit, wherein
in cooling of the substrate by the gas introducing unit, a condition for the cooling is set such that an amount of cooling of the substrate in the first thin film forming region is larger than an amount of cooling of the substrate in the second thin film forming region.

2. The thin film forming apparatus according to claim 1, wherein the condition for the cooling is set such that an introduction amount of the gas in the first thin film forming region is larger than an introduction amount of the gas in the second thin film forming region.

3. The thin film forming apparatus according to claim 1, wherein the condition for the cooling is set such that the gap between the cooling body and the substrate in the first thin film forming region is narrower than the gap between the cooling body and the substrate in the second thin film forming region.

4. The thin film forming apparatus according to claim 1, wherein the gap maintaining unit is a roller.

5. A thin film forming method using a thin film forming apparatus configured to form a thin film in vacuum on a front surface of a band-shaped substrate having the front surface and a rear surface,
the thin film forming apparatus comprising:
a transfer mechanism configured to transfer the substrate;
a thin film forming unit configured to form the thin film on the front surface of the substrate in a thin film forming region, the substrate being transferred linearly;
a cooling body provided close to the rear surface of the substrate in the thin film forming region and cooled down by a cooling medium;
a gas introducing unit configured to introduce a gas to between the cooling body and the rear surface of the substrate to cool down the substrate;
a gap maintaining unit contacting the rear surface of the substrate for dividing the thin film forming region into a first thin film forming region and a second thin film forming region where a film forming speed is lower than that in the first thin film forming region, and maintaining a gap between the cooling body and the substrate; and
a vacuum container configured to store the transfer mechanism, the thin film forming unit, the cooling body, the gas introducing unit, and the gap maintaining unit,
the method comprising the step of:
forming the thin film on the front surface of the substrate under a condition in which in cooling of the substrate by the gas introducing unit, an amount of cooling of the substrate in the first thin film forming region is larger than an amount of cooling of the substrate in the second thin film forming region.

6. The thin film forming method according to claim 4, wherein the condition is adjusted such that an introduction amount of the gas in the first thin film forming region is larger than an introduction amount of the gas in the second thin film forming region.

7. The thin film forming method according to claim 4, wherein the condition is adjusted such that the gap between the cooling body and the substrate in the first thin film forming region is narrower than the gap between the cooling body and the substrate in the second thin film forming region.

8. The thin film forming method according to claim 4, wherein the condition is adjusted such that the gas introduced in the first thin film forming region is formed by molecules each having a lower molecular weight than each of molecules of the gas introduced in the second thin film forming region.
